(19) United States
(12) Patent Application Publication
(10) Pub. No.: US 2007/0223693 A1
(43) Pub. Date: Sep. 27, 2007

(54) Compensating Watermark Irregularities Caused By Moved Objects

(75) Inventor: Adriaan Johan Van Leest, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/569,976

(22) PCT Filed: May 31, 2005
(86) PCT No.: PCT/IB05/51767

§ 371 Date: Dec. 4, 2006

(30) Foreign Application Priority Data
Jun. 8, 2004 (EP) 04102595.8

(51) Int. Cl. H04N 7/26

(52) U.S. Cl. 380/210

(57) ABSTRACT

The present invention relates to a method, device and computer program product for determining additional data to be embedded in a media signal as well as a media signal processing device having such a device for determining additional data. The device for determining additional data comprises an embedding unit (28). The embedding unit has a motion compensating unit (32), which obtains, from a media signal (X) divided into frames having blocks of a number of signal sample values, at least one motion vector (V) of a current frame that is associated with a first block of signal samples and retrieves additional data (W_{P0}) embedded in a previous frame of the signal in dependence of the motion vector. The embedding unit also has a correcting unit (36), which determines coefficients of the retrieved additional data based on additional reference data (W_{R}) as well as a data embedding unit (38) that embeds the corrected additional data into the first block.

### TECHNICAL FIELD

The present invention generally relates to the field of watermarking of media signals, preferably video signals for instance coded according to the MPEG coding scheme. More particularly the present invention is directed towards a method, device and computer program product for determining additional data to be embedded in a media signal as well as a media signal processing device having such a device for determining additional data.

### DESCRIPTION OF RELATED ART

It is well known to watermark media signals in order to protect the rights of content owners against piracy and fraud. A watermark is here normally a pseudo-random noise code that is inserted in the media signal.

In the watermarking process it is necessary that the watermark is not perceptible. A watermark that is embedded in for instance a video signal should then not be visible for an end user. It should however be possible to detect the watermark safely using a watermark detector, therefore the watermark should furthermore retain its structure throughout the signal.

One known watermarking scheme for a video signal is described in WO-02/060182. Here a watermark is embedded in an MPEG video signal. An MPEG signal is received and comprises VLC (Variable-Length Coding) coded quantised DCT (Discrete Cosine Transform) samples of a video stream divided into frames, where each frame includes a number of blocks of pixel information. In this watermarking scheme the quantised DCT samples are obtained from the VLC coded stream and the watermark is directly embedded in this domain. A watermark is here embedded in the quantised DCT components of a block of size 8×8 under the use of a bit-rate controller, such that only the small DCT levels with ±1 are modified into a zero value. These values are furthermore only modified if the bit rate of the stream is not increased.

However, when an object that is coded in a frame in such a signal moves, the watermarking components embedded in this object are also moved, which often leads to an incorrect watermark that does not reflect the true watermark any more. This makes the detection harder.

It would therefore be advantageous if the watermarking according to the above described scheme could be improved when objects provided in a video signal are moved.

### SUMMARY OF THE INVENTION

It is therefore an object of the present invention to provide a scheme for embedding additional data in a media signal, where the effects on the additional data of a moved object coded in the signal are limited.

According to a first aspect of the present invention, this object is achieved by a method of determining additional data to be embedded in a media signal and comprising the steps of:

obtaining, from a media signal divided into frames having blocks of a number of signal sample values, at least one motion vector of a current frame that is associated with a first block of signal samples,

retrieving additional data embedded in a previous frame of said signal in dependence of the motion vector,

determining additional data coefficients to be embedded in said signal based on the retrieved additional data and additional reference data, and

embedding said additional data coefficients into said first block.

According to a second aspect of the present invention, this object is also achieved by a device for determining additional data to be embedded in a media signal, comprising an embedding unit having:

a motion compensating unit arranged to:

obtain, from a media signal divided into frames having blocks of a number of signal sample values, at least one motion vector of a current frame that is associated with a first block of signal samples,

retrieve additional data embedded in a previous frame of said signal in dependence of the motion vector,

a determining unit arranged to determine additional data coefficients to be embedded in said signal based on said retrieved additional data and additional reference data, and a data embedding unit arranged to embed the said additional data coefficients into said first block.

According to a third aspect of the present invention, this object is also achieved by a media signal processing device comprising a device for determining additional data according to the second aspect.

According to a fourth aspect of the present invention, this object is also achieved by a computer program product for determining additional data to be embedded in a media signal, comprising computer program code, to make a computer do, when said program is loaded in the computer:

obtain, from a media signal divided into frames having blocks of a number of signal sample values, at least one motion vector of a current frame that is associated with a first block of signal samples,

retrieve additional data embedded in a previous frame of said signal in dependence of the motion vector, and

determine additional data coefficients to be embedded in said signal based on said retrieved additional data and additional reference data, and embed said additional data coefficients into said first block.

According to claim 2, additional data retrieved using one motion vector is provided for a second block of said previous frame that the motion vector is pointing to, and additional reference data is data identifying what the additional data to be embedded should resemble.

According to claims 3 and 9 the additional data is a watermark and the direction of change of the coefficients of a retrieved part of a previous frame watermark is compared with the direction of change of the coefficients of a corresponding part of the reference watermark, and those direction of changes of the retrieved watermark coefficients that differ from the direction of changes of the reference watermark coefficients are changed into the direction of changes of the reference watermark coefficients by means of adding corresponding correcting coefficients. The correcting coefficients are then embedded in the signal. This feature limits the amount of processing needed to restore a watermark without raising the bit-rate of the signal.

According to claims 4 and 11, the correcting coefficients are added to the part of the retrieved watermark and the result is stored as a part of a previous frame watermark for correction of following frames, which ensures that the watermark can be restored also in other frames.

According to claims 5 and 10 the retrieving is performed in the spatial domain, and the correction and embedding are performed in the DCT domain. The motion vector is associated with the spatial domain, which means that the retrieving then has to be performed there, while the watermark embedding has to be made in the DCT domain.

According to claim 7 the current frame is a frame that is predicted only based on a frame to be presented before the current frame. This feature allows a lowered complexity of the correcting scheme according to the invention.

The present invention has the advantage of restoring the embedded additional data to what it should be in case an object coded in a media signal is moved. This allows the retaining of a high correlation between the embedded additional data and the additional data intended to be embedded.

The essential idea of the invention is that additional data, which is to be embedded in a signal where a coded object is moved, is motion compensated with motion vectors associated with the object. The motion compensated additional data and additional reference data are then used for determining additional data to be embedded, in order to restore the intended information of the additional data.

These and other aspects of the invention will be apparent from and elucidated with reference to the embodiments described hereinafter.

### BRIEF DESCRIPTION OF THE DRAWINGS

The present invention will now be explained in more detail in relation to the enclosed drawings, where

FIG. 1 schematically shows a number of frames of video information in a media signal,

FIG. 2 schematically shows one such frame of video information where a watermark has been provided, where the frame is divided into a number blocks,

FIG. 3 shows an example of a number of luminance levels in the spatial domain for one intraframe coded block,

FIG. 4 shows DCT levels corresponding to the luminance levels in FIG. 3 for the block,

FIG. 5 shows the default intra quantizer matrix for the block in FIGS. 3 and 4,

FIG. 6 shows the scanning of quantised DCT coefficients for obtaining a VLC coded video signal,

FIG. 7 shows the default inter quantizer matrix for an interceded block,

FIG. 8 shows a device for embedding additional data according to the present invention,

FIG. 9 shows a block schematic of an embedding unit in more detail according to the present invention, and

FIG. 10 schematically shows a computer program product comprising computer program code for performing the method according to the invention.

### DETAILED DESCRIPTION OF EMBODIMENTS

The invention is directed towards the embedding of additional data in a media signal. Such additional data is preferably a watermark. However the invention is not limited to watermarks but can be applied for other types of additional data. The media signal will in the following be described in relation to a video signal and then an MPEG coded video signal. It should be realised that the invention is not limited to MPEG coding, but other types of coding can just as well be contemplated.

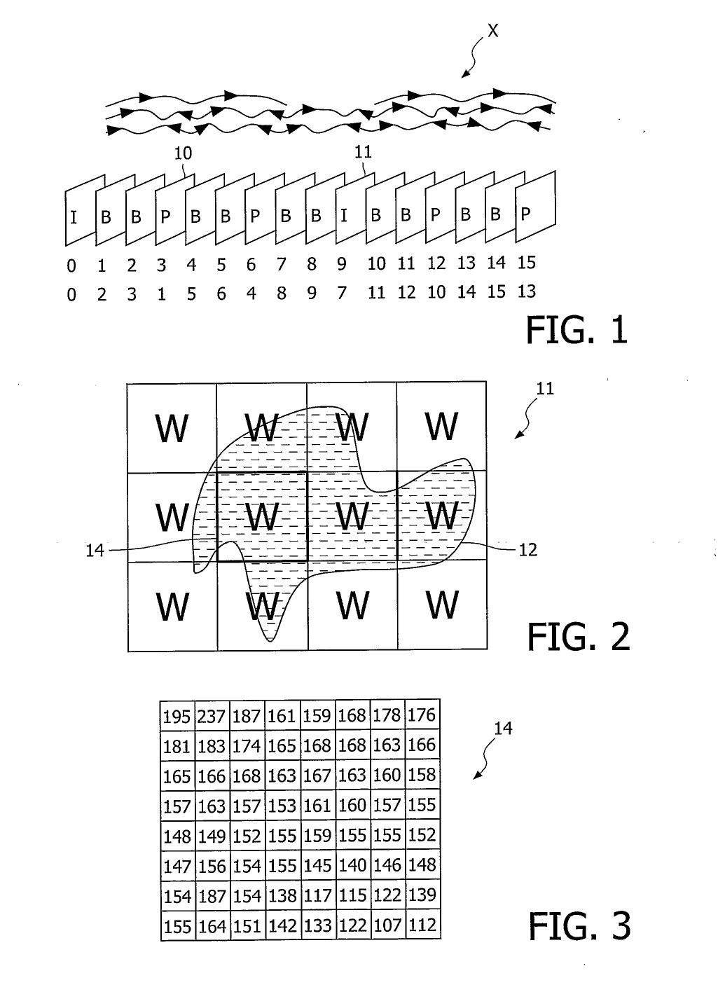

A video signal or stream X according to the MPEG standard is schematically shown in FIG. 1. An MPEG stream X comprises a number of transmitted frames or pictures denoted I, B and P. FIG. 1 shows a number of such frames shown one after the other. Under the frames a first line of numbers is shown, where these numbers indicate the display order, i.e. the order in which the information relating to the frames is to be displayed. Below the first line of numbers, there is shown a second line of numbers indicating the transmission and decoding order, i.e. the order in which the frames are received and decoded in order to display a video sequence. Above the frames there are shown arrows that indicate how the frames refer to each other. It should be realised that the stream also includes other information such as overhead information.

The different types of frames are divided into I-, B- and P-pictures, where one such picture that is a P-picture is indicated with reference numeral 10. An I-picture is denoted with reference numeral 11. I-pictures are so-called intraframe coded pictures. These pictures are coded independently of other pictures and thus contains all the information necessary for displaying an image. P- and B-pictures are so called interframe coded pictures that exploit the temporal redundancy between consecutive pictures and they use motion compensation to minimize the prediction error. P-pictures refer to one picture in the past, which previous picture can be an I-picture or a P-picture. B-pictures refer to two pictures one in the past and one in the future, where the picture referred to can be an I- or a P-picture. Because of this the B-picture has to be transmitted after the pictures it refers to, which leads to the transmission order being different than the display order.

The principles of coding will now be described in relation to intracoded blocks, because here the principles of the coding are most clearly seen. In an intracoded picture, i.e. an I-picture, the frame contains a number of pixels, where the luminance and chrominance are provided for each pixel. In the following, focus will be made on the luminance, since watermarks are embedded into this property of a pixel. Each such frame is further divided into 8×8 pixel blocks of luminance values. One such frame 11 is shown in FIG. 2, which shows an object 12 provided in the stream. As an example, there is here provided twelve 8×8 pixel blocks of luminance values, where there are four such blocks in the horizontal direction and three in the vertical. All of the blocks in the figure are furthermore watermarked, which is here indicated with the letter w in order to show that a watermark is embedded in these blocks. It should be known that watermarks are in general, not visible. One of the blocks 14 is highlighted and will be used in relation to the description of the MPEG coding.

FIG. 3 shows an example of some luminance values y for the block indicated in FIG. 2.

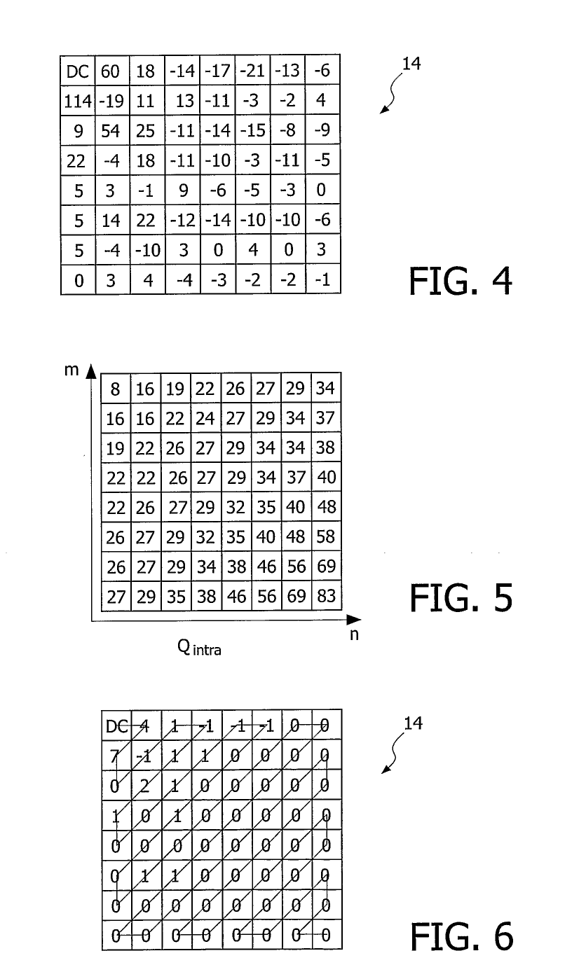

In the process of performing the coding of intracoded blocks, a DCT (Discrete Cosine Transform) operation is performed on these blocks resulting in 8×8 blocks of DCT coefficients. FIG. 4 shows such a DCT coefficient block for the block in FIG. 3. The coefficients contain information on the horizontal and vertical spatial frequencies of the input block. The coefficient corresponding to zero horizontal and vertical frequency is called a DC component, which is the coefficient in the upper left corner of FIG. 4. Typically for natural images these coefficients are not evenly distributed, but the transformation tends to concentrate the energy to the low frequency coefficients, which are in the upper left corner of FIG. 4.

Thereafter the AC coefficients in the intracoded block are quantised by applying a quantisation step q*Qᵢₙₜᵣₐ(m, n)/16. FIG. 5 shows the default quantisation values Qᵢₙₜᵣₐ used here. The quantisation step q can be set differently from block to block and can vary between 1 and 112.

After this quantisation the coefficients in the blocks are serialized into a one dimensional array of 64 coefficients. This serialisation scheme is here a zigzag scheme as shown in FIG. 6, where the first coefficient is the DC component and the last entry represents the highest spatial frequencies in the lower corner on the right side. From the DC component to this latest component the coefficients are connected to each other in a zigzag pattern.

The one dimensional array is then compressed or entropy coded using a VLC (variable length code. This is done through providing a limited number of code words based on the array. Each code word denotes a run of zero values, i.e. the number of zero valued coefficients preceding a quantised DCT coefficient followed by a non zero coefficient of a particular level. This leads to the creation of the following line of code words for the values in FIG. 6:

(0,4), (0,7), (1,−1), (0,1), (0,−1), (0,1), (0,2), (0,1), (2,1), (0,1)(0,−1), (0,−1), (2,1), (3,1), (10,1), EOB

where EOB indicates the end of the block.

These so-called run/level pairs are then converted to digital values using a suitable coding table. In this way the luminance information has been highly reduced.

As mentioned above an I-frame only comprises intracoded blocks. P- and B-frames include intercoded blocks where the coefficients represent prediction errors instead. In the overhead information of such a frame there is also provided motion vectors related to the intercoded blocks. It should however be noted that P- and B-frames might also contain intracoded blocks.

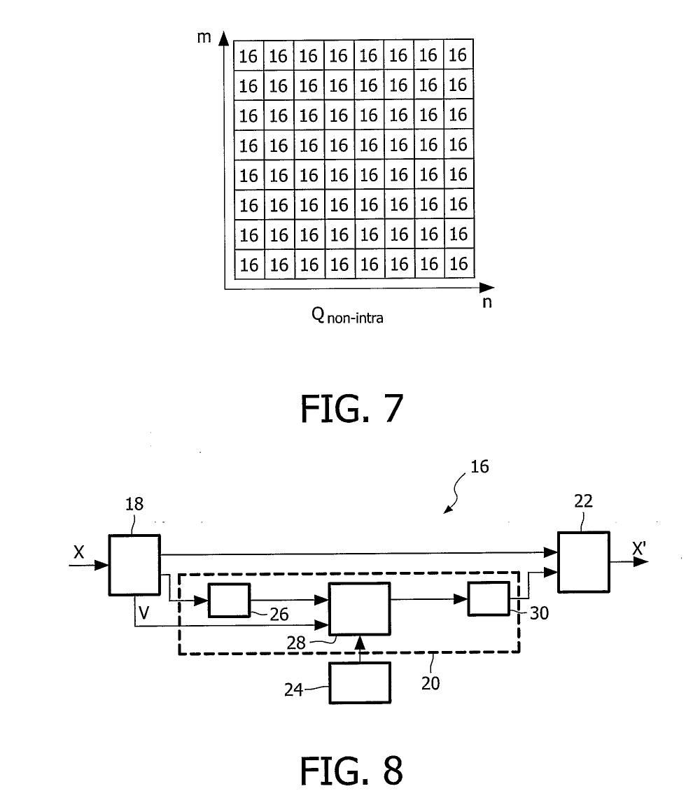

An interceded block is, as was mentioned above, handled in a similar manner as an intracoded block when being coded. The difference here is that the DCT coefficients do not represent luminance values but rather prediction errors, which are however treated in the same way as the intracoded coefficients. In the quantisation a quantisation step is applied according to q*Qₙₒₙ₋ᵢₙₜᵣₐ(m, n)/16. FIG. 7 shows the default quantisation values Qₙₒₙ₋ᵢₙₜᵣₐ used here. The quantisation step q can be set differently from block to block and can also here vary between 1 and 112.

As is indicated above additional information in the form of a watermark is embedded in the different blocks. A typical algorithm is the so-called run-merge algorithm described in WO-02/060182, which is herein incorporated by reference.

According to this document, a watermark w, in the form of a pseudo-random noise sequence, is embedded in the blocks of a frame. A watermark is here provided as a number of identical tiles provided over the whole image and where one tile can have the size of 128×128 pixels. The watermark tile is divided into blocks corresponding to the size of the DCT blocks and transformed into the DCT domain and these DCT blocks are then stored in a watermark buffer. In this algorithm the watermark is embedded in the quantised DCT coefficients under the control of a bit-rate controller. The watermark is embedded by adding ±1 to the smallest quantised DCT level. However since many of the signal coefficients are zero an addition of ±1 may lead to an increased bit rate, which is disadvantageous. There is furthermore a risk that the watermark will be visible.

Therefore the watermark is embedded such that no modification of the signal is performed if a modification would lead to an increased bit-rate. Only the smallest quantised DCT levels ±1 are turned into a zero according to the watermark.

This can be seen as:

$${ℓ}_{out} ( i , j ) = \{ \begin{matrix}0 & if {ℓ}_{i n} ( i , j ) + w ( i , j ) = 0 and the budget allows it , \\ {ℓ}_{i n} ( i , j ) & otherwise ,\end{matrix}$$

where lᵢₙ is the quantised input DCT level w is the watermark and lₒᵤₜ is the resulting watermarked quantised DCT level.

A media processing device for solving this problem is generally shown in FIG. 8.

The media processing device includes a parsing unit 18, a device for determining additional data 20 and an output stage 22. The parsing unit is connected to the device 20 as well as to the output stage 22, also the device 20 is connected to the output stage 22. The device 20 includes a first processing unit 26, connected to an embedding unit 28 and a second processing unit 30. A watermark buffer 24 is connected to the embedding unit 28. This watermark buffer 24 will later be called a reference watermark buffer for reasons that will become clear by the description.

In normal operation the parsing unit 18 receives a media signal X in the form of a number of video images or frames including blocks with VLC coded code words. The parsing unit separates the VLC coded code words from other types of information and sends the VLC coded code words to the first processing unit 26 of device 20, which processes the stream X in order to recreate the run-level pairs of each block. The parsing unit 18 also separates motion vectors V associated with intercoded blocks and provided in the overhead information of B- and P-frames and provides these motion vectors V to the embedding unit 28, which obtains them in this way. The run-level pairs received by the first processing unit 26, i.e. the quantised DCT coefficient matrix, are then sent to the embedding unit 28. The embedding unit 28 embeds a watermark stored in the watermark buffer, provides the watermarked DCT matrix to the second processing unit 30, that VLC codes it and provides it to the combining unit 22 for combination with the other MPEG codes. From the combining unit 22 the watermarked signal X′ is then provided.

Watermarking is according to the present invention normally handled as outlined in WO-02/060182, but possibly allowing higher or lower levels than ±1 of the watermark coefficients. During normal watermarking of blocks other watermarking levels than ±1 are allowed. Because of limitations set by the allowable bit-rate, it might be necessary to disallow adding watermarks to zero level coefficients, to disallow increased DCT levels of the signal samples but bringing the coefficient level closer to a zero level by adding the watermark. It is furthermore preferred to first dequantise the block coefficients and then add the watermark to the dequantised DCT coefficients, also here so that the bit-rate is not increased. The watermark coefficient for the signal coefficient is taken from the watermark buffer 24, where it is stored in the DCT domain. The watermark coefficient here has a value that defines the amount and direction (i.e. the sign) that the corresponding dequantized signal coefficient is to change.

A problem that might be encountered in relation to motion compensation is that when an object in a frame is moved, the watermark embedded in the object is also moved. This movement may cause a change in the spatial watermark so that it does not any longer provide the correct spatial watermark. The watermark can thus become distorted.

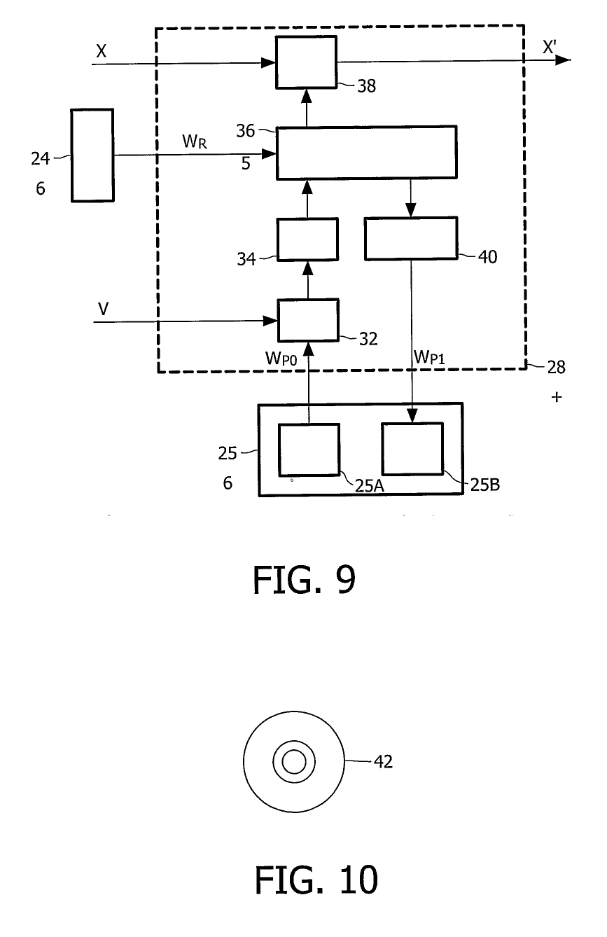

An embedding unit 28 for solving the above mentioned problem is shown in a block schematic in FIG. 9. The embedding unit 28 comprises a motion compensating unit 32 connected to a preceding frame watermark buffer 25. The motion compensating unit 32 is furthermore connected to a DCT transforming unit 34. The DCT transforming unit 34 is connected to a determining unit 36, which in turn is connected to a data embedding unit 38. The determining unit 36 is furthermore connected to the reference watermark buffer 24 and to an inverse DCT transforming unit 40, which is also connected to the preceding frame watermark buffer 25. The preceding frame watermark buffer has here been divided into a first buffer 25A and a second buffer 25B. The first buffer 25A comprises the watermark embedded in a previous frame, while the second buffer 25B comprises the watermark embedded in the present or current frame, which will be used as a reference watermark for the following frame.

The functioning of the device in FIG. 9 will now be described under the assumption that the object 12 in FIG. 2 is moved in a P-frame. Here a preceding watermark W_{P0} in the spatial domain related to a previous frame has been stored in the first buffer 25A. The motion compensating unit 32 obtains the vectors V of all blocks of the P-frame in a consecutive fashion by counting rows and columns of the frame using a block counter and getting the vectors of the positions one by one. Each vector is associated with a first block position of the current frame and also points out a second position of a previous frame from where the corresponding block has been moved. If no motion vector is associated with a block, the vector in question has zero length. For each vector, the motion compensating unit then retrieves a previous frame watermark W_{P0} block corresponding to the second position the vector is pointing to. In case the vector is zero the first and second positions are the same. The retrieved previous frame watermark W_{P0} blocks are then moved to the first positions of the current blocks, i.e. the positions associated with the vectors. This can be seen as the previous frame watermark block being motion compensated using the vector V such that now it has moved from the second to the first position. The retrieved and reordered previous frame watermark blocks W_{P0} are then provided to the DCT transforming unit 34, which transforms the previous frame blocks from the spatial domain into the DCT domain and provides them to the determining unit 36. In the determining unit 36 the watermark to be embedded is determined based on the retrieved and reordered previous frame watermark and a reference watermark. This is done through the reference watermark W_{R}, which comprises data supposed to be embedded, being compared block by block with the reordered previous frame watermark W_{P0}. Thus here a first block of the reference watermark is compared with a second block of the previous frame watermark.

The determination, which is here done by correcting the previous frame watermark W_{P0}, is done in the following way. The directions of changes or signs of the motion compensated previous frame watermark coefficients are compared with the signs of the corresponding reference watermark coefficients. For a given first and second block combination those coefficients of the motion compensated second block that are the same as the signs of the first block, nothing is done. If the coefficients of the second block were all zero, i.e. no watermark was provided in that block of the previous frame, nothing is done also in this case. For the coefficients of the motion compensated second block that differ from the signs of the coefficients of the first block, the signs of the second block coefficients are changed to the opposite sign, i.e. + is turned into − and vice versa. This is done by adding correcting coefficients. The correcting coefficients are added to the second block coefficients such that they resemble the first block coefficients. Thus it is ensured that the motion compensated watermark coefficients receive the same sign as the reference watermark coefficients. This is what always happens. If the bit-rate is not increased, the levels of the correcting coefficients are furthermore raised and ideally they receive double the value of the second block coefficients in order to completely restore the watermark. The reason for this is that the prediction error is added to the motion compensated frame, and therefore to obtain a watermark with an opposite sign the watermark has to be embedded with twice the energy. It might here be necessary to have a lower level than twice the original energy level, to only limit the change to a sign change or to provide a zero level, i.e. to skip the level, for other reasons than increased bit-rate and that is when the quantisation step associated with the block to be corrected is too large. Such a level correction could then lead to the watermark becoming visible. The watermark coefficients can here also be quantised instead of dequantised.

When the determining unit 36 thus has partially corrected the motion compensated second blocks if necessary, the correcting coefficients are supplied to the data embedding unit 38, which embeds them in the signal X. Thus only correcting coefficients are embedded in the interceded blocks of the current frame of the signal. In case the correcting coefficients were dequantised, the data embedding unit then first quantises them before embedding and in case they were already quantised, they are directly embedded in the signal.

The determining unit 36 furthermore adds the correcting coefficients to the retrieved and reordered watermark. For coefficients where no correction takes place the sum only consists of the retrieved coefficient. The result of the addition is then provided to the inverse DCT transforming unit 40, which performs an inverse DCT transformation in order to obtain a previous frame watermark W_{P1} in the spatial domain. This previous frame watermark is then provided to the second watermark buffer 25B for storing as a new previous frame watermark for a following frame.

With the method described above, the watermark retains the structure that it should have, which is important when detecting the watermark. The watermark furthermore remains invisible. By changing the signs of the coefficients a high correlation is retained when only the signs have been used to embed the watermark in the DCT domain.

There are a number of variations that can be made to the present invention. It is possible to change more than one block within one frame. A P-frame may also comprise intracoded blocks, where the correction according to the invention is not used. However the watermark coefficients for this block will then be stored in the second buffer of the preceding frame watermark buffer. It is possible to restrict the correction to only the above-described P-pictures, since these pictures are used as reference for other P- and B-pictures. This means that only for I- and P-frames the embedded watermark is stored in buffers for future use, and the watermark is motion compensated in the P-pictures, which reduces the amount of processing needed. It should however be realised that it can also be implemented for B-pictures. In the case of B-frames there would be needed an extra previous frame buffer because the motion compensation depends on at most two buffers. In the case of B-pictures the coefficients of the two previous frames are furthermore added to each other and divided by two. The correction process thus becomes more complex for a B-frame. It is furthermore possible that the motion compensation might be possible to perform in the DCT domain, in which case the reference watermark might be stored also in this domain and in which case there would be no need for the DCT transforming unit and the inverse DCT transforming unit.

The present invention has been described in relation to a watermark embedding unit. This embedding unit is preferably provided in the form of one of more processors containing program code for performing the method according to the present invention. This program code can also be provided on a computer program medium, like a CD ROM 42, which is generally shown in FIG. 10. The method according to the invention is then performed when the CD ROM is loaded in a computer. The program code can furthermore be downloaded from a server, for example via the Internet.

It should be emphasized that the term “comprises/comprising” when used in this specification is taken to specify the presence of stated features, integers, steps or components, but does not preclude the presence or addition of one or more other features, integers, steps, components or groups thereof. It should furthermore be realized that reference signs appearing in the claims should in no way be construed as limiting the scope of the present invention.

1. Method of determining additional data to be embedded in a media signal and comprising the steps of:
obtaining, from a media signal (X) divided into frames (10, 11) having blocks (14) of a number of signal sample values, at least one motion vector (V) of a current frame that is associated with a first block of signal samples,
retrieving additional data (W_{P0}) embedded in a previous frame of said signal in dependence of the motion vector,
determining additional data coefficients to be embedded in said signal based on said retrieved additional data (W_{P0}) and additional reference data (W_{R}), and
embedding said additional data coefficients into said first block.

2. Method according to claim 1, wherein additional data retrieved using one motion vector is provided for a second block of said previous frame that the motion vector is pointing to, and additional reference data is data identifying what the additional data to be embedded should resemble.

3. Method according to claim 1, wherein the additional data is a watermark having a number of coefficients to be embedded in the signal samples, further comprising the step of obtaining said media signal (X), and where
the step of retrieving further comprises retrieving at least part of a stored previous frame watermark (W_{P0}) based on the motion vector, and
the step of determining comprises correcting said part of the previous frame watermark through:
comparing the direction of change of the coefficients of said retrieved part (W_{P0}) of the previous frame watermark with the direction of change of the coefficients of a corresponding part of the reference watermark (W_{R}),
changing those direction of changes of the retrieved watermark coefficients that differ from the direction of changes of the reference watermark coefficients into the direction of changes of the reference watermark coefficients by means of adding corresponding correcting coefficients, and
the step of embedding comprises embedding the correcting coefficients.

4. Method according to claim 3, further comprising the step of adding said correcting coefficients to said part of the retrieved watermark and storing the result as a part of a previous frame watermark (W_{P1}) for use in correcting following frames.

5. Method according to claim 3, wherein the previous frame watermark is provided in the spatial domain, the step of retrieving is performed in the spatial domain, and further comprising the step of transforming at least the retrieved watermark coefficients to the DCT domain and performing the steps of correcting and embedding in the DCT domain.

6. Method according to claim 1, wherein the media signal is provided in another domain than the spatial domain.

7. Method according to claim 1, wherein said current frame is a frame (P) that is predicted only based on a frame to be presented before the current frame.

8. Device (20) for determining additional data to be embedded in a media signal, comprising an embedding unit (28) having:
a motion compensating unit (32) arranged to:
obtain, from a media signal (X) divided into frames (10, 11) having blocks (14) of a number of signal sample values, at least one motion vector (V) of a current frame that is associated with a first block of signal samples, and
retrieve additional data (W_{P0}) embedded in a previous frame of said signal in dependence of the motion vector,
a determining unit (36) arranged to determine additional data coefficients to be embedded in said signal based on said retrieved additional data (W_{P0}) and additional reference data (W_{R}), and
a data embedding unit (38) arranged to embed said additional data coefficients into said first block.

9. Device according to claim 8, wherein the additional data is a watermark, the motion compensating unit is further arranged to:
retrieve from a first watermark buffer (25A) at least a part of a stored previous frame watermark (W_{P0}) based on the motion vector,
the determining unit when performing the determining is arranged to correct the previous frame watermark through:
comparing the direction of change of the coefficients of said retrieved part (W_{P0}) of the previous frame watermark with the direction of change of the coefficients of a corresponding part of the reference watermark (W_{R}), and
changing those direction of changes of the retrieved watermark coefficients that differ from the direction of changes of the reference watermark coefficients into the direction of changes of the reference watermark coefficients by means of adding corresponding correcting coefficients, and
the data embedding unit (38) is further arranged to obtain said media signal and embed said correcting coefficients in said signal.

10. Device according to claim 9, wherein the motion compensating unit is arranged to retrieve the previous frame watermark in the spatial domain, the embedding unit further comprises a DCT transforming unit (34) arranged to transform at least said part of the retrieved watermark to the DCT domain such that the determining unit can perform the correction and the data embedding unit can perform the embedding of the watermark in the DCT domain.

11. Device according to claim 10, wherein the embedding unit further comprises an inverse DCT transforming unit (40) and the determining unit is further arranged to add said correcting coefficients to said part of the retrieved watermark for forwarding the result to the inverse DCT transforming unit for transforming into the spatial domain for storage as a previous frame watermark (W_{P1}) in a second watermark buffer (25B).

12. Media signal processing device (16) comprising a device for determining additional data (20) according to claim 8.

13. Computer program product (42) for determining additional data to be embedded in a media signal, comprising computer program code, to make a computer do, when said program is loaded in the computer:
obtain, from a media signal divided into frames having blocks of a number of signal sample values, at least one motion vector of a current frame that is associated with a first block of signal samples,
retrieve additional data embedded in a previous frame of said signal in dependence of the motion vector,
determine additional data coefficients to be embedded in said signal based on said retrieved additional data and additional reference data, and
embed said additional data coefficients into said first block.
